(19) United States
(12) Patent Application Publication
(10) Pub. No.: US 2009/0212905 A1
(43) Pub. Date: Aug. 27, 2009

(54) Wireless remote control system for vehicle functions

(75) Inventors: Thomas Batz, Besigheim (DE); Joachim Bunke, Esslingen (DE); Fritz Class, Roemerstein (DE); Andreas Doufrain, Esslingen (DE); Holger Enigk, Rangsdorf (DE); Volker Entemmann, Affalterbach (DE); Thomas Ganz, Esslingen (DE); Martin Gloeckner, Stuttgart (DE); Thomas Heising, Murrhardt (DE); Paul Heisterkamp, Erbach (DE); Marcus Hohloch, Stuttgart (DE); Ralf Krause, Gerlingen (DE); Helmut Mayer, Karlsruhe (DE); Wim Nettelnstroth, Berlin (DE); Armin Ramminger, Hohenstadt (DE); Dimitrios Saraoudis, Kleinmachnow (DE); Burkhard Schloer, Karlsbad (DE); Helmut Schuler, Gaertringen (DE); Robert Sechtin, Nuertingen (DE); Marcelo Sordi, Sao Paulo (BR); Thomas Viereck, Emmendingen (DE); Johannes Weiland, Plochingen (DE); Nina Weitzel, Stuttgart (DE); Michael Wolf, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/659,187

(22) PCT Filed: Jul. 30, 2005
(86) PCT No.: PCT/EP05/08288

§ 371 Date: Dec. 9, 2008

(30) Foreign Application Priority Data
Aug. 4, 2004 (DE) 10 2004 037 707.3

(51) Int. Cl. H04L 9/32; G08C 19/00; G06F 19/00

(52) U.S. Cl. 340/5.54; 340/5.2; 701/2

(57) ABSTRACT

The invention relates to a wireless remote control system (100) for vehicle functions (13.1, 13.2), having a portable remote control unit (20) which comprises operator control elements for activating control signals which are exchanged with a vehicle mounted transmitter/receiver unit (11) in order to control the vehicle functions (13.1, 13.2). According to the invention, the remote control unit (20) comprises the following components: at least one first operator control element which has a predefined function of an electronic driving authorization and/or access authorization system (13.2) assigned to it, and at least one second operator control element and at least one display unit for menu prompted control of at least one ride level control system (13.1).

### BACKGROUND AND SUMMARY OF THE INVENTION

This invention relates to a wireless remote control system for vehicle functions.

Modern utility vehicles are equipped with a pneumatic suspension comprising a ride level control system which makes it possible to raise or lower a chassis frame. The ride level control system is used when picking up or setting down interchangeable open bodies, containers and/or semitrailers as well as when loading and unloading the utility vehicle. For example, a quasi-fixed remote control system is used as the operator control unit for the ride level control system. The remote control is attached to a helical cable on the driver's seat and has a plurality of pushbutton keys arranged on it. Various functions of the ride level control system are permanently assigned to the pushbutton keys. In addition, light emitting diodes which indicate which operating mode is selected can be provided on the operator control unit.

Since the quasi-fixed operator control unit is connected to the driver's cab via the helical cable, the freedom of movement of the driver when operating the ride level control system is greatly restricted. For example, it is thus not possible to control the ride level control system from the vehicle body and/or from the trailer. For this reason, additional fixed operator control units are frequently installed for the ride level control system in the vehicle body and/or in the trailer in order to be able to configure the working sequences efficiently. This redundancy of course gives rise to raised costs.

In addition, the restricted freedom of movement of the driver can also have an adverse effect on operational reliability since the raising or lowering cannot always be monitored from an optimum position. If the driver additionally moves away from the driver's cab during a relatively long-lasting raising or lowering process, in the event of an incident he cannot press the stop key immediately but instead firstly has to run back to the driver's cab.

German document DE 38 10 386 A1 describes an infrared remote control system for a ride level control system for a lorry, with which ride level control system a vehicle body can be raised or lowered with respect to at least one axle. The remote control system comprises a portable infrared transmitter and a receiver which is integrated into the control device of the ride level control system. After use, the portable remote control can be stored in a storage receptacle.

German document DE 44 03 467 C2 describes a ride level control system for a goods vehicle with pneumatic suspension and with a remote control.

German document DE 101 37 149 A1 describes a communication device for vehicles which uses a mobile telephone for communication with the vehicle, in particular for actuating an electronic control device which is arranged in the vehicle. The mobile telephone is used for actuating a ride level control system which is provided in the vehicle.

German document DE 199 05 172 A1 describes a wireless remote control system for the remote control of functions in motor vehicles, in particular for radio remote control of an electronically controlled pneumatic suspension system in utility motor vehicles. The remote control system comprises at least one vehicle mounted transmitter/receiver unit and a remote control unit which communicates with the transmitter/receiver unit and transmits at least remote control signals. The remote control unit has transmission means which maintain preferably bidirectional communication between the remote control unit and the at least one transmitter/receiver unit during the operation of the remote control unit. In addition, the remote control unit and the at least one transmitter/receiver unit have loss protection means which detect an interruption in the communication between the remote control unit and the at least one transmitter/receiver unit and display the loss of the remote control unit at least at the start of a journey.

The object of the invention is to specify a wireless remote control system for vehicle functions which permits convenient control with a reduced risk of loss.

The invention achieves this object by making available a remote control system for vehicle functions having the features claimed.

Advantageous embodiments and developments of the invention are also claimed.

According to the invention, a portable remote control unit comprises, according to a first aspect, at least one first operator control element which has a predefined function of an electronic driving authorization and/or access authorization system assigned to it, and at least one second operator control element and at least one display unit for menu prompted control of at least one further vehicle function, the at least one further controllable vehicle function being at least one ride level control system, i.e. the individual functions of the ride level control system can advantageously be selected by means of a menu and carried out.

By virtue of the menu structure for controlling the ride level control system it is possible to adapt the functionality of the remote control unit easily by software to different equipment levels of the vehicle and use-specific and market-specific requirements. Since the same hardware can always be used for all the equipment variants, the production numbers can be increased and the costs reduced. In addition, control by means of a menu permits better user prompting when controlling the ride level control system. For example, only the functions which are currently permissible can always be offered to the user. If the user switches the ride level control system on, for example, at first only the functions with which he can select the operating mode (chassis frame front/rear) are then offered to him. The menu is not expanded with the further functions (raising, lowering etc.) until he has defined the operating mode. The same applies to the stop function. This is automatically offered to the user after he has started a control process. Furthermore, more functions can be accommodated in the menu than on a restricted number of function keys. “Concealed” functions, which have to be carried out nowadays for example by pressing two function keys at the same time, are thus no longer necessary.

According to the invention, the portable remote control unit comprises, according to a second aspect, at least one first operator control element which has a predefined function of an electronic driving authorization and/or access authorization system assigned to it, at least one second operator control element for controlling at least one further vehicle function, and a cover which, in a first position, covers the at least one second operator control element, and in a second position clears the at least one second operator control element, the at least one further controllable vehicle function being at least one ride level control system.

By means of the cover it is possible to embody the portable remote control unit as a compact unit with small dimensions which in the folded open state, i.e. with the cover in the second position, make available enough area to be able to accommodate a sufficiently large number of second operator control elements. By means of the cover it is advantageously possible to protect the second operator control elements for the at least one further vehicle function against unintentional operation and against damage when the cover is in the first position. In addition, in the closed state, i.e. with the cover in the first position, electrical components can be switched off and energy can thus be saved.

In a refinement, the first embodiment can also additionally be embodied with a cover.

In the two embodiments, the driver can freely move around the vehicle by means of the wireless communication between the remote control unit and the driver as the ride level control system is controlled. In particular, the driver can also control the ride level control system from the vehicle body and/or the trailer using the same device. As a result it is possible to dispense with redundant, fixed operator control units. In addition, the driver can monitor the raising and lowering of the vehicle from an optimum position and can interrupt the control process at any time without previously having to run to the driver's cab. The mobile operator control unit thus makes a significant contribution to increasing the operational reliability.

As a result of the combination of the mobile remote control unit and the electronic vehicle key in one unit, the risk of loss of the mobile operator control unit is reduced since the user is accustomed to being careful with the vehicle key since without the key he can no longer move the vehicle. Since the remote control unit is plugged, for example into a docking station, in order to start the vehicle and is usually left there for the duration of driving, the energy store of the mobile remote control unit can be charged during driving by the docking station via a corresponding interface, as a result of which the power supply is ensured. At the same time, the mobile operator control unit only has to be located in the docking station to start the engine. As a result, the driver can remove the mobile operator control unit, and thus the vehicle key, from the docking station and even from the driver's cab, even when the engine is running without having to switch off the engine to do so. As a result, it is possible to control the ride level control system from outside the vehicle even when the engine is running.

In order to control the functions of the electronic vehicle key, i.e. of the electronic driving authorization and/or access authorization system, special function keys which have the corresponding functions permanently assigned to them are provided on the mobile remote control unit. This ensures that the functions of the electronic vehicle key can be accessed by the driver directly at any time.

The cover can be moved, for example, by means of a pivoting movement and/or a sliding movement, from the first position into the second position, and vice versa. The folding open or sliding of the cover can be supported, for example, by a spring.

In a further refinement of the remote control system, operator control elements and/or audible indicator means and/or visual display means and/or the display unit are integrated into the cover, as a result of which the dimensions of the portable remote control unit can be made even smaller.

In a further refinement of the remote control system, the cover can be locked in the first and/or second position, in which case in the second position the cover advantageously acts as a handle for the remote control unit.

In a further refinement of the remote control system, it is possible to access the operator control elements for the driving authorization and/or access authorization system in both positions of the cover. This advantageously ensures that access is possible to these operator control elements at any time.

In order to avoid unnecessary energy consumption, the mechanical, electrical and/or electronic components of the remote control unit which are necessary to control the further vehicle functions are deactivated in the first position of the cover.

In order to increase operator control convenience, in a further refinement of the invention the mechanical, electrical and/or electronic components of the remote control unit, which are necessary to control the further vehicle functions, of the vehicle functions which can be controlled with the second operator control elements are activated when the cover moves from the first position into the second position, and deactivated when the cover moves from the second position into the first position.

The cover is designed, for example, in such a way that in the first position it covers the front side of the remote control unit and in the second position it clears the front side.

In a refinement of the remote control system, the operator control elements comprise means for clear haptic feedback so that the control is also possible with working gloves, for example, on a building site, when saddling up and unsaddling etc.

The means for haptic feedback have, for example, a clear pressure point in the case of pushbutton keys and/or four way actuators, or have highly pronounced rotational forces in the case of rotary actuators.

In order to improve further the control with working gloves the operator control elements are, for example, arranged in such a way that single-handed control is possible with a thumb or with a thumb and an index finger.

In a further refinement, the remote control unit is of symmetrical design, permitting the same control for left-handed and right-handed people.

In a further refinement of the remote control system, the operator control elements and the display unit for the menu prompted control are arranged on the front side and/or on the side faces of the remote control unit, and the operator control elements for the driving authorization and/or access authorization system are arranged on the rear side of the remote control unit. This permits simple manufacture of the remote control unit without movable housing parts. The laterally arranged operator control elements allow the control by means of a menu to be carried out with one hand using a thumb and index finger. In order to protect the pushbutton keys against unintentional control they can be protected by grip depressions.

In a further embodiment, the functions for starting and stopping the vehicle engine are integrated in the portable remote control unit. As a result, when necessary, it is possible to start the engine even without entering the driver's cab in order to request the compressed air necessary for the ride level control system. Since the driver's cab no longer has to be entered, the working sequences can be shortened and the physical efforts for the driver reduced further.

In a further refinement of the remote control system, for the duration of a control process of the ride level control system, a stop function can be temporarily assigned to a plurality of operator control elements on the portable remote control unit in order to permit the control process which has been started to be aborted immediately. This advantageously increases the operational reliability.

In a further refinement, the remote control system comprises a voice control unit which is arranged in the portable remote control unit or in the vehicle-mounted control unit, a microphone for picking up voice commands being arranged in the portable remote control unit.

A further vehicle function which can be controlled with the portable remote control unit is, for example, a tire pressure monitoring function which can be controlled with the at least one second operator control element. The tire pressure monitoring function is used, in particular, to teach newly mounted wheels and to standardize the newly mounted wheels. Conventional tire pressure monitoring functions are controlled, for example, by means of steering wheel keys and the combined instrument. This means that when the tires are changed and the standardization of the tire pressure monitoring system which is necessary in such a case is carried out, the driver has to get in and out of the driver's cab repeatedly in order to perform alternating operator control actions and raise or lower the tire pressure. By controlling the tire pressure monitoring function with the portable remote control unit the driver can advantageously remain at the tire, which considerably speeds up the entire process and reduces the physical effort for the driver.

In a further refinement of the remote control system, the vehicle functions which can be controlled with the portable remote control unit can advantageously be modified and/or expanded by transmitting new program codes, i.e. by means of what is referred to as a software update.

In a further refinement of the remote control system, the functions of the electronic driving authorization and/or access authorization system can be disabled and/or enabled by means of, for example, a PIN which is input by the authorized user. The PIN can be input, for example, by means of the at least one second operator control element. The advantage of this embodiment is that the driver can hand over the remote control unit to other persons who are responsible, for example, for loading and unloading and who can then control the further vehicle functions, for example the ride level control or the tire pressure monitoring, but do not have access to the driver's cab and have no driving authorization.

The dimensions of the portable remote control unit have, for example, a height in the range from 30 mm to 90 mm, a width in the range from 20 mm to 70 mm and a thickness in the range from 10 mm to 25 mm, with the dimensions applying to a cover which is present in the first position. These dimensions permit the remote control unit to be embodied in a compact way, similar to a conventional electronic vehicle key, which can however simultaneously be operated with working gloves.

Advantageous embodiments of the invention are illustrated in the drawings and will be described below.

### BRIEF DESCRIPTION OF THE DRAWINGS

FIG. 1 shows a block circuit diagram of a wireless remote control system for vehicle functions,

FIG. 2 shows a schematic front view of a first exemplary embodiment of a remote control unit,

FIG. 3 shows a schematic rear view of the first exemplary embodiment of the remote control unit,

FIG. 4 shows a schematic illustration of a second exemplary embodiment of a remote control unit in the folded open state,

FIG. 5 shows a schematic illustration of the second exemplary embodiment of the remote control unit in the folded closed state,

FIG. 6 shows a schematic illustration of a third exemplary embodiment of the remote control unit in the folded open state,

FIG. 7 shows a schematic illustration of the third exemplary embodiment of the remote control unit in the folded closed state,

FIG. 8 shows a schematic illustration of a fourth exemplary embodiment of the remote control unit in the folded open state, and

FIG. 9 shows a schematic illustration of the fourth exemplary embodiment of the remote control unit in the folded closed state.

### DETAILED DESCRIPTION OF THE INVENTION

As is apparent from FIG. 1, a wireless remote control system 100 for vehicle functions 13.1, 13.2 comprises a portable remote control unit 20 which comprises operator control elements 22 to 29 for activating control signals and a display unit 21, a transmitter/receiver unit 11 arranged in the vehicle 10 and a vehicle-mounted control unit 12. In order to control the vehicle functions 13.1, 13.2, the portable remote control unit 20 and the transmitter/receiver unit exchange data evaluated by the control unit in order to actuate the vehicle functions 13.1, 13.2. The remote control unit 20 comprises, in a first embodiment, at least one first operator control element 26, 27, 28 which has predefined functions of an electronic driving authorization and/or access authorization system 13.2 assigned to it, at least one second operator control element 22 to 25 and at least one display unit 21 for menu-prompted control of at least one further vehicle function, the at least one further controllable vehicle function 13.1 being at least one ride level control system.

The menu-prompted control allows the user first to preselect the operating mode. A corresponding selection defines whether the height of the chassis frame is to be changed at the front and/or rear. Feedback of this preselection is given on the display unit 21. The driver can then likewise raise or lower the chassis frame or adjust it to the driving position or to a previously stored height by means of a corresponding selection in the menu. Since under certain circumstances the raising or lowering may take several minutes, the respective control process is triggered by a single activation of the operator control element. This process is then continued until either the final height is reached or the driver triggers the stop function. The menu structure also permits a plurality of chassis frame heights to be stored and called again.

Furthermore, the portable remote control unit 20 can easily be adapted to new functional scopes with the menu structure. Moreover only control functions which have to be controlled or set at that moment can be displayed to the user. This predefines a specific operator control sequence which also permits an untrained user to perform the operator control processes without faults.

In a second embodiment, the remote control unit 20 comprises at least one first operator control element 26, 27, 28 which has a predefined function of an electronic driving authorization and/or access authorization system 13.2 assigned to it, at least one second operator control element 22 to 25 for controlling at least one further vehicle function and at least one cover 30 which in a first position covers the at least one second operator control element 22, 23, 24, 25, and in a second position clears the at least one second operator control element 22, 23, 24, 25, the at least one further controllable vehicle function being at least one ride level control system 13.1.

This second embodiment permits cost-effective manufacture of the remote control system for basic vehicles with a minimal functional and equipment level, in which, for example, only function keys are provided on an inner side of the cover. Optionally, it is possible to add simple audible or visual display means, for example LEDs for function feedback.

In addition, one of the further vehicle functions 13.1 which can be controlled with the portable remote control unit 20 can be a tire pressure monitoring function.

For reasons of operational reliability it is possible to provide that for the duration of the control process the stop function is temporarily assigned to all the operator control elements of the portable remote control unit 20 in order in an emergency to be able to activate the stop function quickly in an emergency and interrupt the raising or lowering of the chassis frame at any time.

It is possible, as a further embodiment, to combine the cover of the second embodiment with the menu-prompted control of the first embodiment.

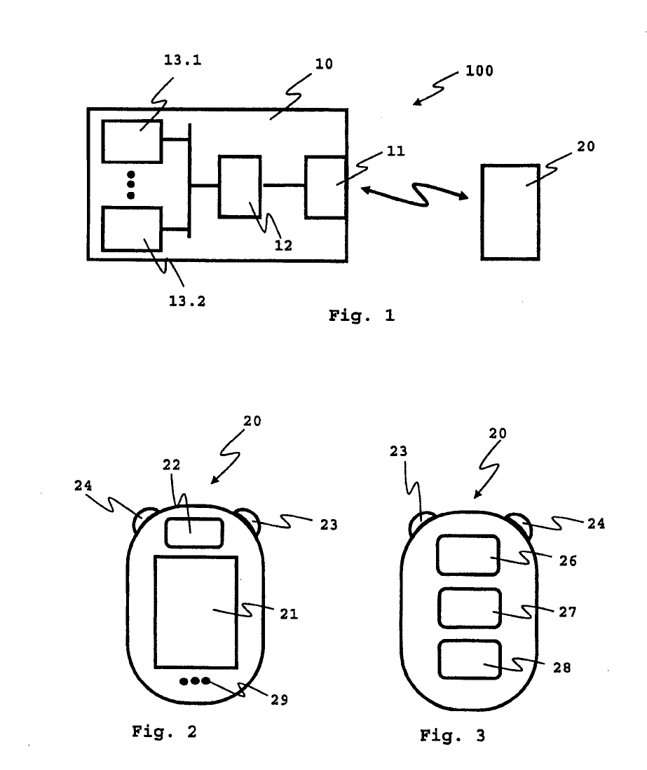

Possible exemplary embodiments of the portable remote control unit will be described below with reference to FIGS. 2 to 9.

The first exemplary embodiment of the portable remote control unit 20 illustrated in FIGS. 2 and 3 is defined by the fact that the essential operator control elements 23, 24 for menu prompting are arranged laterally on the housing of the remote control unit, permitting single-handed operation of the operator control elements 23, 24 for the control by means of a menu using a thumb and an index finger. In addition, virtually the entire area on the front side of the housing is available for the display unit 21, as is apparent from FIG. 2. In order to control the functions of the electronic driving authorization and/or access authorization system 13.2, three first operator control elements 26, 27 28, which have predefined functions of the electronic driving authorization and/or access authorization system 13.2 permanently assigned to them, are arranged on the rear side of the remote control unit 20, as is illustrated in FIG. 3. As is also illustrated in FIGS. 2 and 3, the remote control unit 20 can be embodied as a very compact and mechanically simple device. For example, simple pushbutton keys, burred wheels or a combination of the two can be used as operator control elements 22 to 28. In order to protect the operator control elements 22 to 28 against unintentional operation, corresponding grip depressions may be present on the housing. In order to differentiate between manufacturing series and to personalize the remote control unit 20 it is possible to make the side parts removable and/or exchangeable.

In order to save energy, the display unit 21 can be switched off automatically if, for example, a menu key has no longer been activated within a specific time period. A particular operator control sequence, for example simultaneous and/or relatively long activation of the left-hand and/or right-hand menu key 23, 24, can be provided for the manual activation and/or deactivation of the display unit 21.

The second exemplary embodiment of the portable remote control unit 20 which is illustrated in FIGS. 4 and 5 comprises a cover 30 with which the operator control element 25 arranged on the front side and the display unit 21 can be covered. In this configuration, a four way actuator 25 can be used for the control by means of a menu and pushbutton keys 26 to 28 for the execution of a function. The cover 30 which can be folded open serves as a handle and in the second exemplary embodiment it does not contain any electronic or electrical components so that the display unit 21 and the operator control elements 25, 26, 27, 28 are integrated in one housing. In order to control the functions of the electronic driving authorization and/or access authorization system 13.2, three first operator control elements 26, 27, 28, which have predefined functions of the electronic driving authorization and/or access authorization system 13.2 permanently assigned to them, are arranged on the rear side of the remote control unit 20, as is illustrated in FIG. 5. When the cover 30 is closed, the operator control element 25 of the menu control system is protected against unintentional operation and the display unit 21 against damage. In the illustrated exemplary embodiment, the display unit 21 and thus the menu control system are activated by folding open the cover 30, and the display unit 21 and the menu control system are deactivated by folding the cover 30 closed. The operator control elements 26, 27, 28 for the electronic driving authorization and/or access authorization system 13.2 are accessible both in the folded open and closed state of the cover 30. The rotational axis of the cover is designated by DA in FIGS. 4 and 5. In an alternative embodiment (not illustrated) with the cover 30, simple operator control elements which are embodied, for example, as pushbutton switches, and simple visual display means can be used instead of the display unit 21 and the four way actuator 25. The visual display means may comprise, for example, one or more light emitting diodes for displaying various operating states of the ride level control system and of the tire pressure display, it being possible to embody the light emitting diodes in different colors. The operator control elements can have, for example, a fixed functional assignment. When the cover 30 is folded closed, the operator control elements are then protected against unintentional operation, and the light emitting diodes are protected against damage. By folding open the cover 30, the ride level control system and the tire pressure monitoring function are activated, and the two functions are deactivated by folding the cover 30 closed.

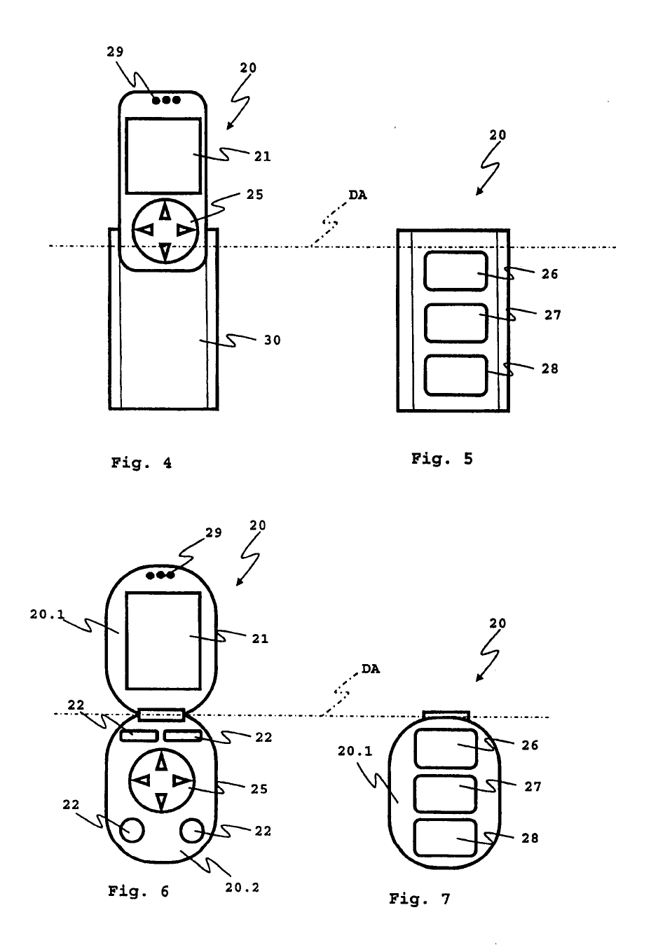

In the third exemplary embodiment of the portable remote control unit 20 illustrated in FIGS. 6 and 7, the housing is composed of an upper part 20.1 and a lower part 20.2 which can be folded together. As is apparent from FIG. 6, the display unit 21 and the operator control elements 22, 25 for the menu control system are on the inside and are distributed among various housing parts 20.1, 20.2. In this embodiment, in the folded together state the display unit 21 is protected against damage and the operator control elements 22, 25 are protected against unintentional activation, while in the folded open state sufficient space is available to accommodate the display unit 21 and the operator control elements 22, 25. The folding opening and folding closed can also be advantageously used for the energy management of the portable remote control unit 20. If the user folds the remote control unit 20 closed and thus signals that he no longer wishes to use it, components with a high energy consumption, for example the display unit, can be switched off. Correspondingly, when the housing is folded open the same components are switched on again. The rotational axis for folding the two housing parts 20.1, 20.2 open and closed is designated by DA in FIGS. 6 and 7. In order to control the functions of the electronic driving authorization and/or access authorization system 13.2, three first operator control elements 26, 27, 28, which have predefined functions of the electronic driving authorization and/or access authorization system 13.2 permanently assigned to them are arranged on the rear side of the upper housing part 20.1 or of the lower housing part 20.2 of the remote control unit 20, as is apparent from FIG. 7.

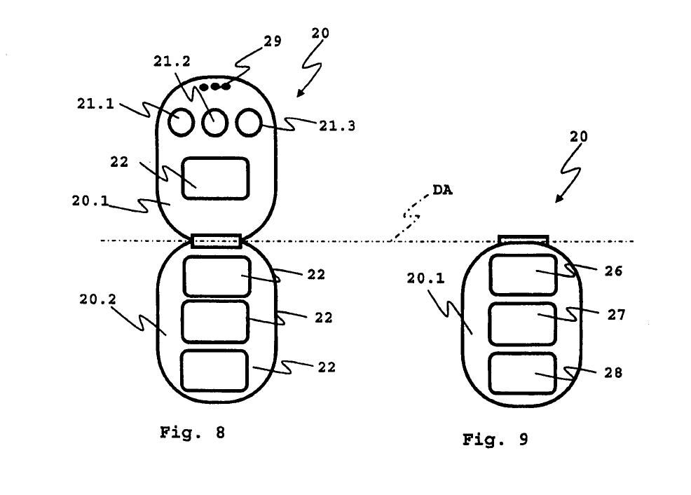

In the fourth exemplary embodiment of the portable remote control unit 20 illustrated in FIGS. 8 and 9, the housing is likewise composed, as in the third exemplary embodiment, of the upper part 20.1 and the lower part 20.2 which can be folded together. However, as is also apparent from FIG. 8, simple visual display means 21.1, 21.2, 21.3 which are embodied as light emitting diodes of various colors are arranged on the inside instead of the display unit 21. In addition, operator control elements 22 with a fixed functional assignment and embodied, for example, as pushbutton switches, are present for controlling the ride level control system 13.1 and the tire pressure monitoring function. The light emitting diodes 22.1, 22.2, 22.3 of various colors serve to display various operating states of the controllable vehicle functions 13.1. The operator control elements 22 for controlling the vehicle functions 13.1 can be distributed between the two different housing parts 20.1, 20.2. In this embodiment, in the folded together state the visual display means 21.1, 21.2, 21.3 are protected against damage, and the operator control elements 22 are protected against unintentional activation, while in the folded open state sufficient space is available to accommodate the display means 21.1, 21.2, 21.3 and the operator control elements 22, 25 and to make them so large that the operator control elements 22, 25 can also be operated with working gloves. The folding open and folding closed processes can, as already stated, also be advantageously used for the energy management of the portable remote control unit 20. If the user folds the remote control unit 20 closed and thus signals that he does not wish to use it any more, components with a high energy consumption can be switched off. Correspondingly, when the housing is folded open the same components are switched on again. The rotational axis for folding the two housing parts 20.1, 20.2 open and closed is designated by DA in FIGS. 8 and 9. In order to control the functions of the electronic driving authorization and/or access authorization system 13.2, three first operator control elements 26, 27, 28, which have predefined functions of the electronic driving authorization and/or access authorization system 13.2 permanently assigned to them, are arranged on the rear side of the upper housing part 20.1 or of the lower housing part 20.2 of the remote control unit 20, as is illustrated in FIG. 9.

In the exemplary embodiments which are described in conjunction with FIGS. 4 to 9, the folding open can be supported by a spring. In addition, the cover 30 or the upper housing part 20.1 can be locked in the two positions. As an alternative to the described folding movement, the cover 30 or the two housing parts 20.1, 20.2 can be moved by a corresponding sliding movement in an alternative embodiment (not illustrated).

So that the remote control unit can also be operated with gloves, for example on a building site, when saddling up and unsaddling etc., the operator control elements should, despite small dimensions, be equipped with clear haptic feedback, for example with a clear pressure point or with pronounced rotational forces. In the folded together state, the dimensions of the portable remote control unit are in the range from 30 to 90 mm for the height, in the range from 20 to 70 mm for the width and in the range from 10 to 25 mm for the thickness.

The predefined functions of the electronic driving authorization and/or access authorization system 13.2, comprise, for example, a means of locking and unlocking the vehicle doors, activating and deactivating an electronic immobilizer and an antitheft warning system, a means for unlocking a steering wheel lock and/or switching on the ignition and means for starting and switching off the engine. In addition, the functions of the electronic driving authorization and/or access authorization system 13.2 can be disabled and enabled again by the driver. This is done by inputting a PIN (Personal Identification Number) by means of the second operator control elements 22 to 25. As a result, the driver can hand over the portable remote control unit 20 to other persons, for example to the persons responsible for loading and unloading. These persons can control the ride level control system and/or the tire pressure monitoring function but do not have access to the driver's cab and also no driving authorization.

It is also conceivable for further vehicle functions to be controlled by means of the operator control elements 22, 23, 24, 25 and the display unit 21, 21.1, 21.2, 21.3 of the portable remote control unit 20. Inter alia, these can be various climatic functions such as additional heating, stationary mode air conditioning system, window, sliding and lifting sunroof, sun blind, vehicle body functions such as lift tail gates, working headlights, load space lights, passenger compartment functions such as radio, CD, DVD, video, interior lighting system, alarm clock and the exterior lighting system such as headlights, flashing indicator lights, fog lights, fog tail lights, rear lights.

In addition, the portable remote control unit 20 can also be used to interrogate and display vehicle data. This includes inter alia, the engine oil level, the reservoir pressures of the brake circuit, the tire pressures, the axle loads, information about the cargo such as temperature, pressure, amount of liquid, service deadlines of the various vehicle components, kilometer reading, tank contents, range, driving times and break times, duration of a journey, distance traveled, average speed, average fuel consumption, diagnostic data and fuel data. Two solutions are technically conceivable here. For example, the data can be transmitted in a wireless fashion, for example by radio, from the vehicle 10 to the mobile operator control unit 20 and merely displayed there. This would have the advantage that current data would always be used. However, it is also possible to buffer all the vehicle data or some of the vehicle data on the portable remote control unit 20. This solution has the advantage that there does not have to be a radio link to the vehicle 10 to display the data.

The portable remote control unit 20 can also be used to inform the driver about particular events relating to the vehicle 10 and/or its cargo. Examples of this are an alarm of the antitheft warning system which is signaled to the driver visually, audibly or by means of vibration, via the portable remote control unit 20. A further example is an alarm which is triggered when the cargo temperature exceeds or drops below the permissible value. Here, the portable remote control unit 20 can contribute to ensuring the uninterrupted monitoring of the cargo which is required by legislators.

A further embodiment of the portable remote control unit 20 can comprise a voice control system with which the vehicle functions can be controlled, settings made of various vehicle systems and vehicle data called. For the voice control system, a microphone 29 is arranged on the portable remote control unit 20 and one of the operator control elements 22 to 28 is embodied as what is referred to as a push-to-talk key. This key has to be activated by the user for as long as he is making a voice input. Two variants are possible for the technical implementation of the voice control system. In one variant, the voice recognition system and the voice dialog system are integrated in the portable remote control unit 20, as a result of which the voice control is possible independently of a radio link to the vehicle. In the other variant, the voice recognition system and the voice dialog system are integrated on a control device 12 in the vehicle 10 and the portable remote control unit 20 merely picks up the voice signal and transmits it into the vehicle 100, as a result of which the hardware requirements (processor power, memory requirement) made of the portable remote control unit 20 are less.

In a further refinement of the remote control system the vehicle functions which can be controlled with the portable remote control unit are advantageously modified and/or expanded by transmitting new program codes, i.e. via what is referred to as a software update. As a result, the functional scope of the remote control can easily be adapted to new developments.

1-23. (canceled)

24. A wireless remote control system for vehicle functions, having a portable remote control unit including operator control elements for activating control signals which are exchanged with a vehicle mounted transmitter/receiver unit in order to control the vehicle functions, and in which the remote control unit comprises:
at least one first operator control element which has assigned to it a predefined function of electronic driving authorization, access authorization or both electronic driving authorization and access authorization, and
at least one second operator control element and at least one display unit for menu prompted control of at least one further controllable vehicle function,
wherein the at least one further controllable vehicle function is provided by at least one ride level control system.

25. The remote control system as claimed in claim 24, wherein the remote control unit has a cover which, in a first position, covers the at least one second operator control element and the display unit, and, in a second position, clears the at least one second operator control element and the display unit.

26. The remote control system as claimed in claim 25, wherein the cover can be moved, by at least one of a pivoting movement and a sliding movement, from the first position into the second position and vice versa.

27. The remote control system as claimed in claim 25, wherein at least one of said operator control elements, an audible indicator, a visual display, and the display unit is integrated into the cover.

28. The remote control system as claimed in claim 25, wherein the cover can be locked in at least one of the first and second positions, and wherein, in the second position, the cover acts as a handle for the remote control unit.

29. The remote control system as claimed in claim 25, wherein it is possible to access the operator control elements for at least one of the driving authorization and the access authorization in both positions of the cover.

30. The remote control system as claimed in claim 25, wherein, in the first position of the cover, the at least one further vehicle function is deactivated with respect to operator control by the remote control unit.

31. The remote control system as claimed in claim 25, wherein the at least one further vehicle function is activated with respect to operator control by the remote control unit when the cover moves from the first position into the second position, and is deactivated when the cover moves from the second position into the first position.

32. The remote control system as claimed in claim 25, wherein, in the first position, the cover covers a front side of the remote control unit, and in the second position, the cover clears the front side.

33. The remote control system as claimed in claim 25, wherein the operator control elements comprise means for clear haptic feedback.

34. The remote control system as claimed in claim 33, wherein the means for haptic feedback have a clear pressure point for at least one of pushbutton keys and four way actuators or pronounced rotational forces for rotary actuators.

35. The remote control system as claimed in claim 24, wherein the operator control elements are arranged so that single handed operation is possible with a thumb or with a thumb and an index finger.

36. The remote control system as claimed in claim 24, wherein the remote control unit is of symmetrical design.

37. The remote control system as claimed in claim 24, wherein the second operator control element and the display unit are arranged on a front side or on side faces of the remote control unit, and wherein the first operator control element is arranged on a rear side of the remote control unit.

38. The remote control system as claimed in claim 24, wherein the second operator control element comprises an operator control element for starting and stopping the vehicle engine.

39. The remote control system as claimed in claim 24, wherein, during a control process of the ride level control system, a stop function which stops the ride level control process is temporarily assigned to a plurality of the operator control elements on the portable remote control unit.

40. The remote control system as claimed in claim 24, wherein a voice control unit is arranged in the portable remote control unit or in a vehicle mounted control unit, and wherein a microphone for picking up voice commands is arranged in the portable remote control unit.

41. The remote control system as claimed in claim 24, wherein a further vehicle function is a tire pressure monitoring function which can be controlled with the at least one second operator control element.

42. The remote control system as claimed in claim 24, wherein vehicle functions which can be controlled with the portable remote control unit can be at least one of modified and expanded by transmitting new program codes.

43. The remote control system as claimed in claim 24, wherein functions of electronic driving authorization, access authorization, or both electronic driving and access authorization can be disabled, enabled, or both disabled and enabled.

44. The remote control system as claimed in claim 43, wherein the functions can be disabled, enabled, or both disabled and enabled by inputting a PIN.

45. The remote control system as claimed in claim 24, wherein the portable remote control unit is dimensioned to have a height in a range from 30 mm to 90 mm, a width in the range from 20 mm to 70 mm, and a thickness in the range from 10 mm to 25 mm, and wherein the height, width, and thickness dimensions apply to a cover which is present in the first position.

46. A wireless remote control system for vehicle functions, having a portable remote control unit including operator control elements for activating control signals which are exchanged with a vehicle mounted transmitter/receiver unit in order to control the vehicle functions, and in which the remote control unit comprises:
at least one first operator control element which has assigned to it a predefined function of electronic driving authorization, access authorization, or both electronic driving authorization and access authorization, and
at least one second operator control element for controlling at least one further controllable vehicle function, and
a cover which, in a first position, covers the at least one second operator control element and, in a second position, clears the at least one second operator control element,
wherein the at least one further controllable vehicle function is at least one ride level control system.

47. The remote control system as claimed in claim 46, wherein the cover can be moved, by at least one of a pivoting movement and a sliding movement, from the first position into the second position and vice versa.

48. The remote control system as claimed in claim 46, wherein at least one of said operator control elements, an audible indicator, a visual display, and the display unit is integrated into the cover.

49. The remote control system as claimed in claim 46, wherein the cover can be locked in at least one of the first and second positions, and wherein, in the second position, the cover acts as a handle for the remote control unit.

50. The remote control system as claimed in claim 46, wherein it is possible to access the operator control elements for at least one of the driving authorization and the access authorization in both positions of the cover.

51. The remote control system as claimed in claim 46, wherein, in the first position of the cover, the at least one further vehicle function is deactivated with respect to operator control by the remote control unit.

52. The remote control system as claimed in claim 46, wherein the at least one further vehicle function is activated with respect to operator control by the remote control unit when the cover moves from the first position into the second position, and is deactivated when the cover moves from the second position into the first position.
